(19) United States
(12) Patent Application Publication
(10) Pub. No.: US 2020/0373618 A1
(43) Pub. Date: Nov. 26, 2020

(54) ELECTROLYTE FOR LITHIUM SECONDARY BATTERY, LITHIUM SECONDARY BATTERY CONTAINING THE SAME

(71) Applicants: Hyundai Motor Company, Seoul (KR); Kia Motors Corporation, Seoul (KR); UNIST (Ulsan National Institute of Science and Technology), Ulsan (KR)

(72) Inventors: Jung Young Cho, Seoul (KR); Yoon Sung Lee, Suwon (KR); Nam-Soon Choi, Ulsan (KR); Koeun Kim, Ulsan (KR); Sung Ji Park, Ulsan (KR); Juyeon Lee, Ulsan (KR)

(21) Appl. No.: 16/654,217

(22) Filed: Oct. 16, 2019

(30) Foreign Application Priority Data
May 23, 2019 (KR) 10-2019-0060446

(51) Int. Cl. H01M 10/0567; H01M 4/505; H01M 4/525; H01M 4/38; H01M 10/0525

(52) U.S. Cl. CPC H01M 10/0567; H01M 4/505; H01M 4/525; H01M 2300/004; H01M 10/0525; H01M 2220/20; H01M 4/386

(57) ABSTRACT

Provided are an electrolyte for a lithium secondary battery and a lithium secondary battery including the same.

The electrolyte for a lithium secondary battery may include a lithium salt, a solvent component and an additive, and the additive may include a compound represented by the following Chemical formula (1).

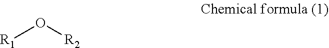

In Chemical Formula (1), R₁ and R₂ are each independently a linear or a branched alkyl group having 2 to 6 carbon atoms and containing 3 or more fluorine atoms.

### CROSS-REFERENCE TO RELATED APPLICATION(S)

This application claims the benefit of priority to Korean Patent Application No. 10-2019-0060446, filed on May 23, 2019 in the Korean Intellectual Property Office, the entire disclosure of which is incorporated herein by reference.

### TECHNICAL FIELD

The present invention relates to an electrolyte for a lithium secondary battery and a lithium secondary battery including the same.

### BACKGROUND

With the technological development of and increasing demand for mobile devices, the demand for secondary batteries as energy sources has increased rapidly, and lithium secondary batteries having high energy density and voltage have been widely used among secondary batteries. Generally, a lithium secondary battery includes an anode, a cathode, a separator disposed between the electrodes, and an electrolyte, wherein the electrolyte in which an appropriate amount of a lithium salt is dissolved in an organic solvent is used.

In order to increase the energy density of lithium secondary batteries, many studies have been conducted on high capacity silicon-based anodes. However, unlike the carbon-based anode such as graphite or the like, the silicon-based anode has a problem that, for example, an interface protection film is not stably maintained due to a large volume change of about 300 to 400% during the charging/discharging process. As a result, various side reactions such as electrolyte decomposition due to repeated charging and discharging continuously occur, resulting in deterioration of the electrode.

Therefore, in order to prevent the problem of deterioration of the electrode, various additives, which are oxidized/reduced to form a protective film on the surface of the cathode and the silicon-based anode before the electrolyte is decomposed by oxidation/reduction reactions, have been developed.

Representative examples of the additives currently used include fluoroethylene carbonate (FEC) capable of forming a solid electrolyte interface (SEI) film on the surface of the silicon-based anode. However, fluoroethylene carbonate (FEC) may form acidic substances such as HF and HPF₆ according to a series of reactions as shown in Reaction Scheme (1) below, which vigorously occur particularly in a high-temperature environment. There is a problem that the formed acidic substances such as HF and HPF₆ may cause elution of a cathode transition metal and destruction of the SEI film, thereby lowering battery lifetime characteristics.

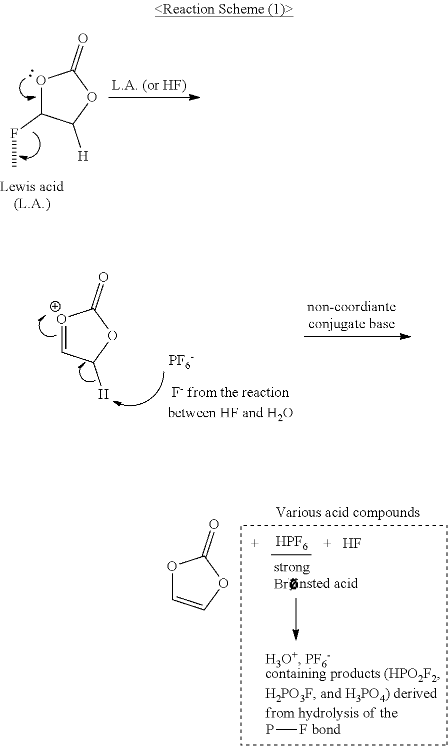

Therefore, there is a need for development of additives capable of securing excellent battery lifetime characteristics by forming a film for protecting a silicon-based anode.

### SUMMARY

In preferred aspects, provided is an additive capable of ensuring excellent battery lifetime characteristics by forming a film for protecting a silicon-based anode. In one aspect, provided is an electrolyte for a lithium secondary battery including a lithium salt, a solvent component and an additive. Particularly, the additive may include a compound represented by Chemical formula (1) below.

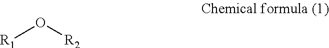

In Chemical formula (1), R₁ and R₂ are each independently a linear or a branched alkyl group having 2 to 6 carbon atoms and containing 3 or more fluorine atoms.

The additive may suitably have a LUMO energy of about −0.6 eV or less.

The compound represented by Chemical formula (1) may be bis trifluoroethyl ether (BTFE).

The additive may suitably include an amount of about 0.2 to 2.0 parts by weight of the compound represented by Chemical formula (1) based on the total weight of the electrolyte.

The additive may further include fluoroethylene carbonate (FEC). Preferably, the additive may include an amount of about 0.2 to 5.0 parts by weight of fluoroethylene carbonate (FEC) based on the total weight of the electrolyte.

The additive may include an amount of about 0.5 to 1.5 parts by weight of the compound of represented by Chemical formula (1), and an amount of about 1.5 to 2.5 parts by weight of fluoroethylene carbonate (FEC) based on the total weight of the electrolyte.

The solvent component may include one or more selected from the group consisting of carbonates, esters, ethers, ketones, and aprotic solvents.

The lithium salt may suitably include one or more selected from the group consisting of LiPF₆, LiBF₄, LiClO₄, LiSbF₆, LiAsF₆, LiN(SO₂C₂F₅)₂, LiN(SO₃C₂F₅)₂, LiN(SO₂F₂)₂, LiCF₃SO₃, LiC₄F₉SO₃, LiC₆H₅SO₃, LiSCN, LiAlO₂, LiAlCl₄, LiN(CₓF₂ₓ₊₁SO₂) (C_{y}F_{2y+1}SO₂) (where x and y are natural numbers), LiCl, LiI, and LiB (C₂O₄)₂.

In another aspect, provided is a lithium secondary battery including electrodes including a cathode and an anode, a separator disposed between the electrodes and an electrolyte including a lithium salt, a solvent component and an additive. In particular, the additive may include a compound represented by Chemical formula (1).

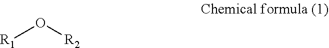

The R₁ and R₂ are each independently a linear or a branched alkyl group having 2 to 6 carbon atoms and containing 3 or more fluorine atoms.

The additive may suitably have a LUMO energy of about −0.6 eV or less.

The cathode may suitably include a cathode active material including Ni, Co, and Mn, and an amount of Ni is in the range of about 60 to 99 wt % based on the total weight of the cathode active material.

The anode suitably may include an anode active material including Si in an amount of about 5 to 90 wt% based on the total weight of the anode active material.

Preferably, the lithium secondary battery may have an ion conductivity of about 8.25 (mS/cm) or greater.

The lithium secondary battery may have about 70% or greater of an initial discharge capacity after 150 charging/discharging cycles at a temperature of about 25° C.

The lithium secondary battery may have about 60% or greater of an initial discharge capacity after 200 charging/discharging cycles at a temperature of about 45° C.

The lithium secondary battery may have a resistance of about 7 Ω or less after 200 charging/discharging cycles at a temperature of about 45° C.

The lithium secondary battery may have about 55% or greater of an initial discharge capacity after 140 charging/discharging cycles at a temperature of about 60° C.

Also provided is a vehicle including the lithium secondary battery as described herein.

Other aspects of the invention are disclosed infra.

According to various exemplary embodiments of present invention, the electrolyte for a lithium secondary battery and the lithium secondary battery including the same may preferably include an additive that forms a film for protecting the electrode and ensures excellent battery lifetime characteristics.

Further, according various exemplary embodiments of the present invention, the electrolyte for a lithium secondary battery and the lithium secondary battery including the same may preferably include an additive capable of securing excellent battery lifetime characteristics even when the driving environment of the battery is a high temperature.

Moreover, according various exemplary embodiments of the present invention, even though the additive is added to the electrolyte for a lithium secondary battery and the lithium secondary battery including the same, the ion conductivity may be maintained and the resistance does not increase significantly during repeated charging/discharging process.

### BRIEF DESCRIPTION OF THE DRAWINGS

FIG. 1 is a graph showing discharge capacity of the secondary batteries according to a reference composition, Example 1, and Comparative Examples 1 and 2 of Table 2 according to the number of charging/discharging cycles.

FIG. 2 is a graph showing discharge capacity of the secondary batteries according to a reference composition, Examples 1 to 3, and Comparative Example 3 of Table 3 according to the number of charging/discharging cycles.

FIG. 3 is a graph showing discharge capacity of the secondary batteries according to Examples 1 to 3 and Comparative Example 3 of Table 4 according to the number of charging/discharging cycles.

FIG. 4 is a graph showing discharge capacity of the secondary batteries according to Example 2 and Comparative Example 3 of Table 5 according to the number of charging/discharging cycles.

FIG. 5 is a graph showing resistance values of the secondary batteries according to the Examples 1 to 3 and Comparative Example 3 of Table 6 according to the number of charging/discharging cycles.

### DETAINED DESCRIPTION

Provided herein is, inter alia, an electrolyte for a lithium secondary battery including a lithium salt, a solvent component and an additive. In particular, the additive may include a compound represented by the following Chemical formula (1).

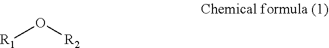

The R₁ and R₂ are each independently a linear or a branched alkyl group having 2 to 6 carbon atoms and containing 3 or more fluorine atoms. Hereinafter, various exemplary embodiments of the present invention will be described. However, the embodiments of the present invention may be modified into various other forms, and the technical idea of the present invention is not limited to the embodiments described below. Further, the embodiments of the present invention are provided to more fully explain the present invention to those skilled in the art.

The terms used in the present application are used only to illustrate specific examples. Thus, for example, the expression of the singular includes plural expressions unless the context clearly dictates otherwise. In addition, the terms “include” or “have,” and the like used in the present application are used to specifically denote the presence of stated features, steps, functions, elements, or combinations thereof and the like, and are not used to preparatorily preclude the presence of elements, steps, functions, components, or combinations thereof.

Unless defined otherwise, all terms used herein should be interpreted to have the same meaning as commonly understood by one of ordinary skill in the art to which this invention belongs. Thus, unless explicitly defined herein, certain terms should not be construed in an overly ideal or formal sense.

It should also be understood that the terms “about,” “substantially,” and the like in the present specification are used in the numerical value or in the vicinity of the numerical value in the meanings mentioned when inherent manufacturing and material allowable errors are presented, and are used to prevent conscienceless intruders from unreasonably using the accurate or absolute numbers, disclosed in the present invention to help understanding of the present invention.

For example, unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about.”

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

Further, in the present disclosure, the term “anode” herein means an anode including silicon (Si), but is not limited to including only silicon.

In an aspect, provided is an electrolyte for a lithium secondary battery that may include a lithium salt, a solvent component and an additive. The additive is represented by the following Chemical formula (1).

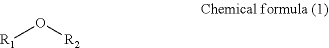

The R₁ and R₂ are each independently a linear or a branched alkyl group having 2 to 6 carbon atoms and containing 3 or more fluorine atoms.

Hereinafter, each component of the electrolyte of the present invention will be described.

Lithium salt

In the present invention, the lithium salt may be a conventional lithium salt, and is not particularly limited. According to an embodiment of the present invention, the lithium salt may include one or more selected from the group consisting of LiPF₆, LiBF₄, LiClO₄, LiSbF₆, LiAsF₆, LiN(SO₂C₂F₅)₂, LiN(SO₃C₂F₅)₂, LiN(SO₂F₂)₂, LiCF₃SO₃, LiC₄F₉SO₃, LiC₆H₅SO₃, LiSCN, LiAlO₂, LiAlCl₄, LiN(CₓF₂ₓ₊₁SO₂)(C_{y}F_{2y+1}SO₂) (where x and y are natural numbers), LiCl, LiI, and LiB (C₂O₄)₂.

Among them, when a compound having a fluorine atom is used as an inorganic lithium salt, free ions promote SEI formation, and a passive film is formed on the surface of the electrodes, whereby an increase in internal resistance may be suppressed. The use of a phosphorus atom-containing compound as an inorganic lithium salt may be more preferable because it facilitates the release of free fluorine atoms. In view of the above, the lithium salt of the present invention is particularly preferably LiPF₆.

Hereinafter, the solvent of this invention will be described in detail.

Solvent Component

The solvent component used in the present invention is not particularly limited as long as it is a conventional solvent (e.g., organic solvent). The solvent component may suitably include one or more selected from the group consisting of a carbonate-based solvent, an ester-based solvent, an ether-based solvent, a ketone-based solvent, and an aprotic solvent.

For example, the carbonate-based solvent may suitably include dimethyl carbonate (DMC), diethyl carbonate (DEC), dipropyl carbonate (DPC), methylpropyl carbonate (MPC), ethylpropyl carbonate (EPC), ethylmethyl carbonate (EMC), ethylene carbonate (EC), propylene carbonate (PC), butylene carbonate (BC), and the like.

The ester-based solvent may suitably include methyl acetate (MA), ethyl acetate (EA), n-propyl acetate (n-PA), 1,1-dimethylethyl acetate (DMEA), methyl propionate (MP), ethyl propionate (EP), γ-butyrolactone (GBL), decanolide, valerolactone, mevalonolactone, caprolactone, and the like.

The ether-based solvent may suitably include dibutyl ether, tetraethylene glycol dimethyl ether (TEGDME), diethylene glycol dimethyl ether (DEGDME), dimethoxy ethane, 2-methyltetrahydrofuran, tetrahydrofuran, and the like.

The ketone-based solvent may suitably include cyclohexanone, and the like.

The aprotic solvent may suitably include nitriles such as R—CN (wherein R is a straight, branched or cyclic hydrocarbon group having 2 to 20 carbon atoms, which may contain a double bond aromatic ring or an ether bond) or the like, amides such as dimethylformamide (DMF) or the like, dioxolanes such as 1,3-dioxolane or the like, and sulfolanes or the like.

The above-mentioned solvents may be used alone or in combination, and when mixed and used, the mixing ratio may be suitably adjusted according to the performance of the desired cell. In addition, although the solvent of the present invention has been exemplified above, the present invention is not limited thereto and can be appropriately designed and changed by those skilled in the art.

For example, a carbonate-based solvent may be used as the solvent component of the present invention, and ethylene carbonate (EC), ethyl methyl carbonate (EMC), dimethyl carbonate (DMC), diethyl carbonate (DEC), and combinations thereof may be used.

Hereinafter, the additive, as a main component of the electrolyte of the present invention, will be described in detail.

Additive

The additive as used herein may be a main component that forms a film for protecting the anode, thereby securing excellent battery lifetime characteristics.

Preferably, the additive may include a compound represented by the following Chemical formula (1).

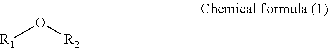

In Chemical formula (1), R₁ and R₂ are each independently a linear or a branched alkyl group having 2 to 6 carbon atoms and containing 3 or more fluorine atoms.

The compound represented by Chemical formula (1) may be bis trifluoroethyl ether (BTFE) represented by Chemical formula (2) below.

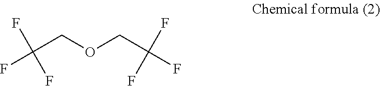 [SMILES: FC(F)(F)COCC(F)(F)F]

In addition, the additive may further include fluoroethylene carbonate (FEC) to secure excellent lifetime characteristics.

When a reductive cleavage tendency of the additive is greater than the solvent component, the additive may be reduced first before the solvent component is reduced during operation of the battery to form an SEI film on the surface of the anode. The formed SEI film on the surface of the anode may protect the anode from deterioration caused by an acidic substance formed by repeated charging/discharging, thereby securing excellent battery lifetime characteristics.

As an example of the solvent component of the present invention, carbonate-based solvents such as EC, EMC, DMC, and DEC may be used, and LUMO energies of EC, EMC, DMC, and DEC are about −0.3310 eV, 0.0435 eV, 0.0479 eV, and 0.0454 eV, respectively. Accordingly, the LUMO energy of the additive in the present invention may be secured to about −0.6 eV or less by controlling the composition ratio of the additive. For example, the LUMO energy of BTFE is about −0.63 eV and the LUMO energy of FEC is about −0.84 eV.

Accordingly, in consideration of the LUMO energies of the respective components, the components may be used alone or in combination, the mixing ratio may be appropriately adjusted to obtain a LUMO energy of about −0.6 eV or less.

In the above, an example of the present invention for controlling the LUMO energy has been described, but the idea of the present invention is not limited thereto, and the compound represented by the Chemical formula (1) and FEC may be used alone or in combination as an additive.

For example, a carbonate-based solvent (EC, EMC, DMC, and DEC) having a less reductive cleavage tendency than that of the additive of the present invention may suitably be used as a solvent component in order to stabilize the electrode interface and the electrolyte bulk.

The additive may suitably include an amount of about 0.2 to 2.0 parts by weight of the compound represented by Chemical formula (1) based on the total weight of the electrolyte. When the additive includes the compound represented by Chemical formula (1) in an amount of less than about 0.2 parts by weight based on the total weight of the electrolyte, it is difficult to sufficiently form a film for protecting the anode, thereby making it difficult to secure battery lifetime characteristics. When the additive includes the compound represented by Chemical formula (1) in an amount of greater than about 2.0 parts by weight based on the total weight of the electrolyte, ion conductivity may be decreased.

The additive may further include fluoroethylene carbonate (FEC) in order to ensure better battery lifetime characteristics, and FEC may be included in an amount of about 0.2 to 5.0 parts by weight based on the total weight of the electrolyte. When the additive includes FEC in an amount of less than about 0.2 parts by weight based on the total weight of the electrolyte, it may be difficult to form a film for protecting the anode and thus it may be difficult to secure battery lifetime characteristics. When the additive includes FEC in an amount of greater than about 5.0 parts by weight based on the total weight of the electrolyte, the ion conductivity may be lowered, and it is not suitable because an acidic substance such as HF and HPF₆ may be formed by excessive addition thereof, which may reduce the battery lifetime characteristics.

Preferably, in consideration of both the reduction of the content of the FEC that may form an acidic material, such as HF, HPF₆ and the like, which reduces the battery lifetime characteristics and the film forming effect on the anode, the additive may include the compound represented by Chemical formula (1) in an amount of about 0.5 to 1.5 parts by weight, and fluoroethylene carbonate (FEC) in an amount of about 1.5 to 2.5 parts by weight, based on the total weight of the electrolyte. The secondary battery including the additive in the above range may have an ion conductivity of about 8.25 mS/cm or greater and a discharge capacity of about 73% or greater after 150 charging/discharging cycles compared to an initial discharge capacity.

Hereinafter, the electrolyte and a lithium secondary battery including the same of the present invention will be described.

Secondary Battery

In an aspect, provided is a lithium secondary battery a including electrodes as described herein, for example, the electrode including a cathode and an anode, a separator disposed between the electrodes, and an electrolyte. The electrolyte may include a lithium salt, a solvent component and an additive, and the additive may include a compound represented by following Chemical formula (1) below.

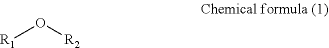

In Chemical formula (1), R₁ and R₂ are each independently a linear or a branched alkyl group having 2 to 6 carbon atoms and containing 3 or more fluorine atoms.

The lithium secondary battery of the present invention may include the additive in the electrolyte to form a film for protecting the anode, thereby securing excellent battery lifetime characteristics. Since the electrolyte of the present invention has been described above, the description of the electrolyte will be omitted below for descriptive convenience.

Any cathode of the present invention may be used as long as it is commonly used in lithium secondary batteries.

According to an example, the cathode may suitably include a cathode active material including Ni, Co, and Mn, and the amount of Ni is in the range of 60 to 99 wt % based on the total weight of the cathode active material.

The cathode active material may suitably include NCM material, such as NCM 811 and NCM 622.

The term “NCM material” as used herein refers to a material consisting of nickel, cobalt, and manganese as a ternary material. In addition, the numbers after the NCM material may be interpreted to mean the ratio of nickel, cobalt and manganese, respectively.

However, it should be noted that the examples of the cathode active materials listed above are only provided to help those skilled in the art, and not to limit the technical idea of the present invention.

The anode of the present invention may be formed of an anode active material including Si in an amount of about 5 to 90 wt % based on the total weight of the anode active material, which may secure a high capacity lithium secondary battery.

The separator of the present invention may be used as long as it is commonly used in lithium secondary batteries. For example, it may be selected from glass fiber, polyester, Teflon, polyethylene, polypropylene, polytetrafluoroethylene (PTFE) or a combination thereof. However, it should be noted that the examples of the separators listed above are only provided to help those skilled in the art, and not to limit the technical idea of the present invention.

The lithium secondary battery according to various exemplary embodiments of the present invention may secure high ion conductivity even though the additive is added. For example, the lithium secondary battery according to an embodiment of the present invention may have an ion conductivity of 8.25 mS/cm or greater.

The lithium secondary battery according to various exemplary embodiments of the present invention may include FEC and the compound represented by Chemical formula (1) alone or in combination as an additive to secure excellent battery lifetime characteristics. For example, the lithium secondary battery may suitably have about 70% or greater of an initial discharge capacity after 150 charging/discharging cycles, about 60% or greater of an initial discharge capacity after 200 charging/discharging cycles, and a resistance of about 7 Ω or less after 200 charging/discharging cycles.

Further, in consideration of both the reduction of the content of the FEC that may form an acidic material, such as HF, HPF₆ and the like, which reduces the battery lifetime characteristics and the film forming effect of the anode, the additive may include most preferably the compound represented by Chemical formula (1) in an amount of about 0.5 to 1.5 parts by weight, and FEC in an amount of about 1.5 to 2.5 parts by weight, based on the total weight of the electrolyte.

The secondary battery including the additive in the above range may have an ion conductivity of about 8.25 mS/cm or greater, and about 73% or greater of the initial discharge capacity after 150 charging/discharging cycles.

Since the lithium secondary battery having the additive of the present invention may have improved lifetime characteristics, it may be used as a power source for various electronic devices. Examples of electronic devices may include air conditioners, washing machines, TVs, refrigerators, freezers, laptops, tablets, smartphones, PC keyboards, displays for PCs, desktop PCs, CRT monitors, printers, integrated PCs, mouse, and hard disks, PC peripherals, and the like.

Hereinafter, the present invention will be described more specifically by way of examples. It should be noted, however, that the following examples are intended to illustrate the invention in more detail and not to limit the scope of the invention. The scope of the present invention is determined by the matters set forth in the claims and the matters reasonably inferred therefrom.

### EXAMPLE

After briefly explaining a manufacturing process of an electrolyte having a reference composition, compositions of each of the examples and comparative Examples shown in Table 1 will be described. Next, performance of each of lithium secondary batteries containing the electrolytes of the examples and comparative Examples will be evaluated based on results shown in Table 1.

Preparation of Reference Composition

As solvents for an electrolyte, ethylene carbonate (EC), ethylmethyl carbonate (EMC), and diethyl carbonate (DEC) were used and mixed in a volume ratio of 25:45:30, respectively, and 0.5M LiPF₆, 0.5M LiFSi were dissolved in the above mixed solvents to prepare the electrolyte. Along with the prepared electrolyte, LiNi_{0.8}Co_{0.1}Mn_{0.1}O₂ was used as a cathode and Si and graphite were used as an anode to prepare a pouch full cell.

### Preparation of Example 1 and Comparative Examples 1 and 2

Example 1 was prepared under the same conditions as the reference composition, except that 1.0 parts by weight of bis trifluoroethyl ether (BTFE) based on the total weight of the electrolyte was added to the additive.

Comparative Examples 1 and 2 were prepared under the same conditions as the reference composition, except that 3.0 parts by weight and 5.0 parts by weight of bis trifluoroethyl ether (BTFE) based on the total weight of the electrolyte were added to the additive, respectively.

### Preparation of Examples 2 and 3 and Comparative Example 3

Example 2 was prepared under the same conditions as the reference composition, except that 1.0 parts by weight of bis trifluoroethyl ether (BTFE) and 3.0 parts by weight of fluoroethylene carbonate (FEC) based on the total weight of the electrolyte were added to the additive.

Example 3 was prepared under the same conditions as the reference composition, except that 1.0 parts by weight of bis trifluoroethyl ether (BTFE) and 2.0 parts by weight of fluoroethylene carbonate (FEC) based on the total weight of the electrolyte were added to the additive.

Comparative Example 3 was prepared under the same conditions as the reference composition, except that 3.0 parts by weight of fluoroethylene carbonate (FEC) based on the total weight of the electrolyte was added to the additive.

Hereinafter, the performance of the lithium secondary battery of each of the examples and comparative examples will be evaluated.

(1) Ion conductivity evaluation: Ion conductivity according to the type of additive The result of measuring the ion conductivity of each of the example and comparative examples is shown in Table 1 below. The parts by weight of Table 1 was calculated as the ratio of the weight of each component compound of the additive based on the total weight of the electrolyte.

TABLE 1

| | Additive | | Ion |
|---|---|---|---|
| | BTFE | FEC | conductivity |
| Sample | (parts by weight) | (parts by weight) | (mS/cm) |
| Reference | — | — | 8.38 |
| composition | | | |
| Example 1 | 1.0 | — | 8.29 |
| Comparative | 3.0 | — | 8.04 |
| Example 1 | | | |
| Comparative | 5.0 | — | 7.84 |
| Example 2 | | | |
| Example 2 | 1.0 | 3.0 | 8.31 |
| Example 3 | 1.0 | 2.0 | 8.35 |
| Comparative | — | 3.0 | 8.28 |
| Example 3 | | | |

It is evaluated below by comparing the ion conductivity of the reference composition without the additive and the ion conductivity of each of the examples and comparative examples of Table 1.

In Example 1, even though 1.0 parts by weight of bis trifluoroethyl ether (BTFE) based on the total weight of the electrolyte was added to the electrolyte, the ion conductivity of Example 1 was measured as 8.29 mS/cm, and it may be seen that the decrease in ion conductivity of Example 1 compared to the reference composition was not considerable. On the other hand, in Comparative Examples 1 and 2, to which 2.0 parts by weight or greater of bis trifluoroethyl ether (BTFE) was added, it may be seen that the decrease in the ionic conductivity of Comparative Examples 1 and 2 was considerable. From this, it may be seen that it is preferable to add the compound represented by Chemical formula (1) and bis trifluoroethyl ether (BTFE) as an example thereof in an amount of 0.2 to 2.0 parts by weight as in the present invention.

In Examples 2 and 3, even though 1.0 parts by weight of bis trifluoroethyl ether (BTFE), 2.0 parts by weight and 3.0 parts by weight of fluoroethylene carbonate (FEC), based on the total weight of the electrolyte were added to the electrolyte, the ion conductivities of Examples 2 and 3 were measured as 8.31 mS/cm, 8.35 mS/cm, respectively, and it may be seen that the decrease in ion conductivities of Examples 2 and 3 compared to the reference composition were not considerable. On the other hand, in Comparative Example 3 to which 3.0 parts by weight of fluoroethylene carbonate (FEC) was added, it may be seen that the decrease in ion conductivity of Comparative Example compared to the reference composition was not considerable. However, the ion conductivity of Comparative Example was not greater than those of Examples 2 and 3.

(2) Lifetime Characteristics Evaluation: Lifetime Characteristics According to Additive Composition (Room Temperature (25° C.))

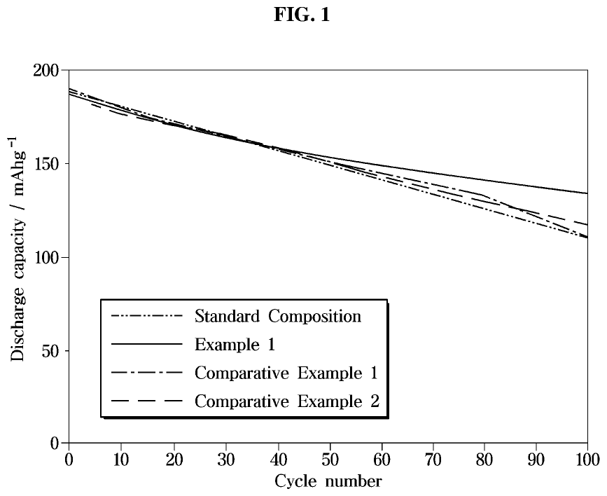

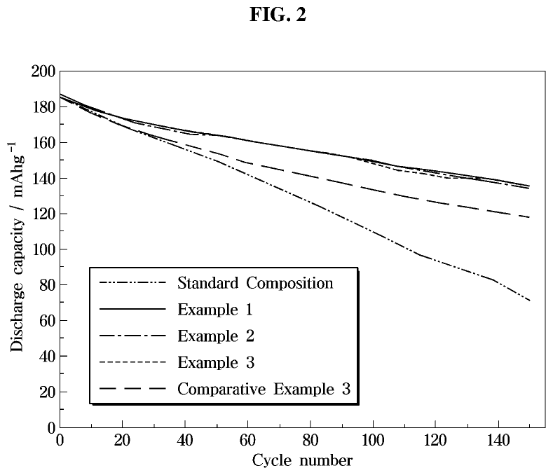

The charging/discharging results of the respective examples and comparative examples are shown in Tables 2, 3 and FIGS. 1, 2. The charging/discharging results of Tables 2 and 3 and FIGS. 1 and 2 were measured at room temperature (25° C.).

In Table 2, 100^{th} lifetime characteristic (%) represents a percentage of a discharge capacity after 100 charging/discharging cycles compared to an initial discharge capacity. In Table 3, 150^{th} lifetime characteristic (%) represents a percentage of a discharge capacity after 150 charging/discharging cycles compared to an initial discharge capacity. In Tables 2 and 3, parts by weight was calculated as a ratio of a weight of each component compound of the additive based on the total weight of the electrolyte.

FIG. 1 is a graph showing discharge capacity of the secondary batteries according to the reference composition, Example 1 and Comparative Examples 1 and 2 of Table 2 according to the number of charging/discharging cycles. As the slope of the discharge capacity shown in FIG. 1 is less, the discharge capacity changes less according to the number of charging/discharging cycles, and thus the lifetime characteristics are greater. In FIG. 1, the horizontal axis represents the number of cycles, and the vertical axis represents discharge capacity (mAh/g).

FIG. 2 is a graph showing discharge capacity of the secondary batteries according to the reference composition, Examples 1 to 3, and Comparative Example 3 of Table 3 according to the number of charging/discharging cycles. As the slope of the discharge capacity shown in FIG. 2 is less, the discharge capacity changes less according to the number of charging/discharging cycles, and thus the lifetime characteristics are greater. In FIG. 2, the horizontal axis represents the number of cycles, and the vertical axis represents discharge capacity (mAh/g).

TABLE 2

| | | | 100^{th} |
|---|---|---|---|
| | Additive | | lifetime |
| | BTFE | FEC | characteristic |
| Sample | (parts by weight) | (parts by weight) | (%) |
| Reference | — | — | 63.1 |
| composition | | | |
| Example 1 | 1.0 | — | 82.7 |
| Comparative | 3.0 | — | 67.9 |
| Example 1 | | | |
| Comparative | 5.0 | — | 69.3 |
| Example 2 | | | |

As shown in Table 2, it may be seen that the 100^{th} lifetime characteristic of Example 1 was superior to that of the reference composition which was without the addition of the additives, and the lifetime characteristic was improved by adding bis trifluoroethyl ether (BTFE).

On the other hand, in the case of Comparative Examples 1 to 2 in which bis trifluoroethyl ether (BTFE) was added in an amount of more than 2.0 parts by weight, the 100^{th} lifetime characteristics were less than that in Example 1. Accordingly, it may be seen that when the bis trifluoroethyl ether (BTFE) is added excessively, the lifetime characteristics may be decreased.

In addition, as shown in FIG. 1, the slope of the discharge capacity according to the cycle number of Example 1 is smaller than those of the reference composition and the Comparative example. From this, it may be seen that since the discharge capacity change according to the number of cycles is small, the lifetime characteristic of Example 1 is superior to the Comparative Example.

TABLE 3

| | Additive | | 150^{th} lifetime |
|---|---|---|---|
| | BTFE | FEC | characteristic |
| Sample | (bars by weight) | (bars by weight) | (%) |
| Reference | — | — | 38.3 |
| composition | | | |
| Example 1 | 1.0 | — | 72.3 |
| Example 2 | 1.0 | 3.0 | 73 |
| Example 3 | 1.0 | 2.0 | 73.3 |
| Comparative | — | 3.0 | 63.7 |
| Example 3 | | | |

As shown in Table 3, it may be seen that the 150^{th} lifetime characteristics of Examples 1 to 3 were significantly superior to that of the reference composition which was without the addition of the additives, and the lifetime characteristics were improved by adding the additives (BTFE and FEC) of the present invention.

On the other hand, in the case of Comparative Example 3 in which only fluoroethylene carbonate (FEC) was added, the 150^{th} lifetime characteristic was lower than those of Examples 1 to 3. Accordingly, it may be seen that when the bis trifluoroethyl ether (BTFE) is added, the lifetime characteristics may be improved.

In addition, the lifetime characteristics of Examples 2 and 3 in which bis trifluoroethyl ether (BTFE) and fluoroethylene carbonate (FEC) were mixed in additive were greater than that of Example 1 in which bis trifluoroethyl ether (BTFE) was used alone in additive. From this, it may be seen that mixing bis trifluoroethyl ether (BTFE) with fluoroethylene carbonate (FEC) is more advantageous for improving lifetime characteristics.

On the other hand, although Example 3 includes less fluoroethylene carbonate (FEC) than Example 2, the lifetime characteristic of Example 3 was greater than that of Example 2. This may be because acidic substances formed due to the addition of fluoroethylene carbonate (FEC) had a greater effect on the deterioration of the electrode than fluoroethylene carbonate (FEC) formed the film of the anode.

Therefore, in consideration of the effect of reducing the FEC content, which may form acidic materials such as HF and HPF₆ degrading battery lifetime characteristics and the forming film of the anode, as in Example 3, it may be seen that it is preferable that additive may include the compound represented by Chemical formula (1) (including BTFE) in an amount of 0.5 to 1.5 parts by weight, and fluoroethylene carbonate (FEC) in an amount of 1.5 to 2.5 parts by weight, based on the total weight of the electrolyte.

Also, as shown in FIG. 2, the slopes of the discharge capacity according to the cycle number of Examples 1 to 3 are less than those of the reference composition and Comparative Example 3. From this, it may be seen that the battery lifetime characteristics of Examples 1 to 3 are superior to those of the reference composition and the Comparative Example 3.

From the above results, it may be seen that the lifetime characteristics are improved by the additive of the present invention. The present invention considers both the reduction of the content of FEC which may form acidic substances such as HF and HPF₆ and the film formation effect of the anode, and includes the FEC and the compound represented by Chemical formula (1) (including BTFE) in an appropriate amount as the additive, thereby securing excellent lifetime characteristics.

(3) Lifetime Characteristics Evaluation: Lifetime Characteristics According to the Additive Composition (High Temperature (45° C., 60° C.))

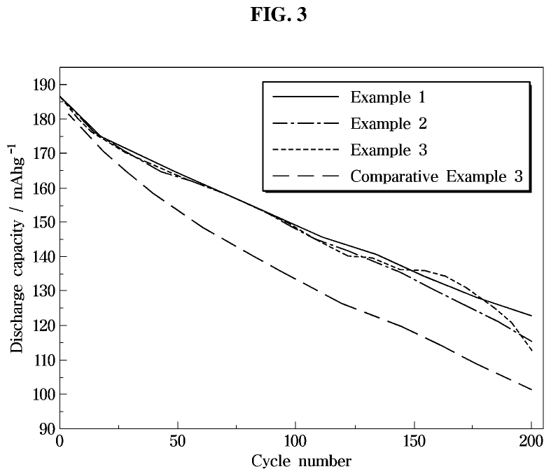

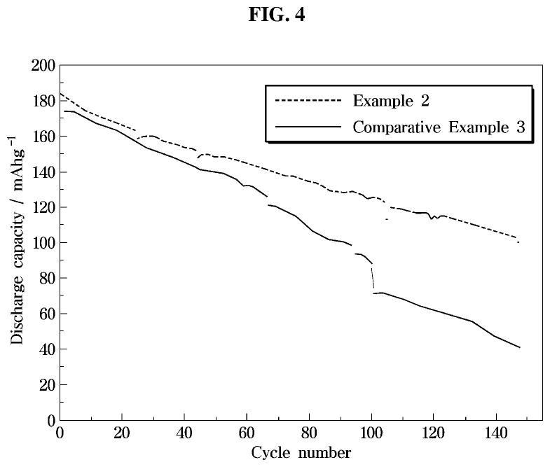

The charging/discharging results of the respective examples and comparative examples are shown in Tables 4 and 5 and FIGS. 3 and 4 below. The charging/discharging test results of Table 4 and FIG. 3 are the results measured at a temperature of 45° C. The charging/discharging results of Table 5 and FIG. 4 are the results measured at a temperature of 60° C.

In Table 4, the 200^{th} lifetime characteristic (%) represents a percentage of the discharge capacity after 200 charging/discharging cycles compared to the initial discharge capacity. In table 5, the 140^{th} lifetime characteristic (%) represents a percentage of the discharge capacity after 140 charging/discharging cycles compared to the initial discharge capacity. In Tables 4 and 5, parts by weight was calculated as the ratio of the weight of each component compound of the additive based on the total weight of the electrolyte.

FIG. 3 is a graph showing discharge capacity of the secondary batteries according to each of the examples and comparative example of Table 4 according to the number of charging/discharging cycles. As the slope of the discharge capacity shown in FIG. 3 is less, the discharge capacity changes less according to the number of charging/discharging cycles, and thus the lifetime characteristics are greater. In FIG. 3, the horizontal axis represents the number of cycles, and the vertical axis represents discharge capacity (mAh/g).

FIG. 4 is a graph showing discharge capacity of the secondary batteries according to each of the examples and comparative example of Table 5 according to the number of charging/discharging cycles. As the slope of the discharge capacity shown in FIG. 4 is less, the discharge capacity changes less according to the number of charging/discharging cycles, and thus the lifetime characteristics are greater. In FIG. 4, the horizontal axis represents the number of cycles, and the vertical axis represents discharge capacity (mAh/g).

TABLE 4

| | Additive | | 200^{th} lifetime |
|---|---|---|---|
| | BTFE | FEC | characteristic |
| Sample | (parts by weight) | (parts by weight) | (%) |
| Example 1 | 1.0 | — | 65.9 |
| Example 2 | 1.0 | 3.0 | 62.0 |
| Example 3 | 1.0 | 2.0 | 61.1 |
| Comparative | — | 3.0 | 54.6 |
| Example 3 | | | |

As shown inTable 4, the 200^{th} lifetime characteristics of Examples 1 to 3 were superior to that of the Comparative Example 3 in which only fluoroethylene carbonate (FEC) was added at a temperature of 45° C. which is high temperature. Accordingly, it may be seen that the lifetime characteristics are improved by adding bis trifluoroethyl ether (BTFE).

On the other hand, unlike the results of the lifetime characteristics at room temperature, the lifetime characteristics of Examples 2 and 3 in which bis trifluoroethyl ether (BTFE) and fluoroethylene carbonate (FEC) are mixed in additive were less than that of Example 1 in which bis trifluoroethyl ether (BTFE) is used alone in additive. This is because fluoroethylene carbonate (FEC) forms an acidic substance such as HF and HPF₆ in a high temperature environment, thereby deteriorating the electrode. Accordingly, when the driving environment of the battery includes a high temperature, it may be seen that bis trifluoroethyl ether (BTFE) alone is advantageous in terms of lifetime characteristics without including fluoroethylene carbonate (FEC).

Also, as shown in FIG. 3, the slopes of the discharge capacity according to the cycle number of Examples 1 to 3 are less than that of Comparative Example 3. From this, it may be seen that the battery lifetime characteristics of Examples 1 to 3 are superior to that of Comparative Example 3.

TABLE 5

| | Additive | | 140^{th} lifetime |
|---|---|---|---|
| | BTFE | FEC | characteristics |
| Sample | (parts by weight) | (parts by weight) | (%) |
| Example 2 | 1.0 | 3.0 | 54.6 |
| Comparative | — | 3.0 | 22.6 |
| Example 3 | | | |

As shown in Table 5, the 140^{th} lifetime characteristic of Example 2 was superior to that of the Comparative Example 3 in which only fluoroethylene carbonate (FEC) was added at a temperature of 60° C. which is high temperature. Accordingly, it may be seen that the lifetime characteristics are improved by adding bis trifluoroethyl ether (BTFE).

Also, referring to FIG. 4, the slope of the discharge capacity according to the cycle number of Example 2 is less than that of Comparative Example 3. From this, it may be seen that the battery lifetime characteristics of Example 2 is superior to that of Comparative Example 3.

From the above results, unlike the case in which the battery lifetime characteristics are secured by the composition of FEC and the compound represented by Chemical formula (1) (including BTFE) in an appropriate amount as the additive at room temperature (25° C.), when the driving environment of the batteries includes a high temperature, it may be seen that it is advantageous to secure excellent lifetime characteristics by including the compound represented by Chemical formula (1) (including BTFE) alone.

(4) Resistance Evaluation: Resistance According to Additive Composition (High Temperature (45° C.))

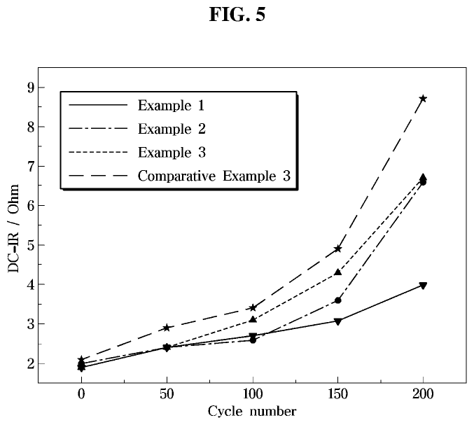

The resistance measurement values of the respective examples and comparative examples are shown in Table 6 and FIG. 5 below. The resistance measurement values of Table 6 and FIG. 5 are the result measured at a temperature of 45° C.

In Table 6, the 200^{th} resistance represents the resistance value after 200 charging/discharging cycles. In Table 6, pars by weight was calculated as the ratio of the weight of each component compound of the additive based on the total weight of the electrolyte.

FIG. 5 is a graph showing resistance values of the secondary batteries according to the examples and comparative examples of Table 6 according to the number of charging/discharging cycles. In FIG. 5, the horizontal axis represents the number of cycles, and the vertical axis represents resistance Ω.

TABLE 6

| | Additive | | | |
|---|---|---|---|---|
| | BTFE | FEC | Initial | 200^{th} |
| | (parts by | (parts by | Resistance | Resistance |
| Sample | weight) | weight) | (Ω) | (Ω) |
| Example 1 | 1.0 | — | 1.9 | 4.1 |
| Example 2 | 1.0 | 3.0 | 2 | 6.6 |
| Example 3 | 1.0 | 2.0 | 1.9 | 6.7 |
| Comparative | — | 3.0 | 2.1 | 8.7 |
| Example 3 | | | | |

As shown in Table 6, the 200^{th} resistance of Examples 1 to 3 were less than that of the Comparative Example 3 in which only fluoroethylene carbonate (FEC) was added at a temperature of 45° C. which is high temperature. Accordingly, it may be seen that the resistance is reduced by adding bis trifluoroethyl ether (BTFE).

On the other hand, the lifetime characteristics of Examples 2 and 3 in which bis trifluoroethyl ether (BTFE) and fluoroethylene carbonate (FEC) were mixed in additive were greater than that of Example 1 in which bis trifluoroethyl ether (BTFE) was used alone in additive. This is because fluoroethylene carbonate (FEC) forms an acidic substance such as HF and HPF₆ in a high temperature environment, thereby deteriorating the electrode. Accordingly, when the driving environment of the battery includes a high temperature, it may be seen that bis trifluoroethyl ether (BTFE) alone is advantageous in terms of low resistance without including fluoroethylene carbonate (FEC).

Also, as shown in FIG. 5, the slope of the resistance according to the cycle number of Examples 1 to 3 is less than that of Comparative Example 3. From this, it may be seen that the resistance changes of Examples 1 to 3 according to the cycle number are relatively small.

From the above results, it may be seen that, when the driving environment of the battery includes a high temperature, it is advantageous to include the compound represented by Chemical formula (1) alone (including BTFE) to ensure low resistance.

As described above, the disclosed embodiments have been described with reference to the accompanying drawings and tables. Those skilled in the art will understand that the present invention may be implemented in a form different from the disclosed embodiments without changing the technical spirit or essential features of the present invention. The disclosed embodiments are exemplary and should not be construed as limiting.

What is claimed is:

1. An electrolyte for a lithium secondary battery comprising:
a lithium salt;
a solvent component; and
an additive,
wherein the additive comprises a compound represented by Chemical formula (1) below, 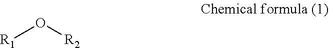
wherein the R₁ and R₂ are each independently a linear or a branched alkyl group having 2 to 6 carbon atoms and containing 3 or more fluorine atoms.

2. The electrolyte of claim 1, wherein the additive has a LUMO energy of about −0.6 eV or less.

3. The electrolyte of claim 1, wherein the compound represented by Chemical formula (1) is bis trifluoroethyl ether (BTFE).

4. The electrolyte of claim 1, wherein the additive comprises an amount of about 0.2 to 2.0 parts by weight of the compound represented by Chemical formula (1) based on the total weight of the electrolyte.

5. The electrolyte of claim 1, wherein the additive further comprises fluoroethylene carbonate (FEC).

6. The electrolyte of claim 5, wherein the additive comprises an amount of about 0.2 to 5.0 parts by weight of fluoroethylene carbonate (FEC) based on the total weight of the electrolyte.

7. The electrolyte of claim 6, wherein the additive comprises an amount of about 0.5 to 1.5 parts by weight of the compound represented by Chemical formula (1), and an amount of about 1.5 to 2.5 parts by weight of fluoroethylene carbonate (FEC) based on the total weight of the electrolyte.

8. The electrolyte of claim 1, wherein the solvent component comprises one or more selected from the group consisting of a carbonate-based solvent, an ester-based solvent, an ether-based solvent, a ketone-based solvent, and an aprotic solvent.

9. The electrolyte of claim 1, wherein the lithium salt comprises one or more selected from the group consisting of LiPF₆, LiBF₄, LiClO₄, LiSbF₆, LiAsF₆, LiN(SO₂C₂F₅)₂, LiN(SO₃C₂F₅)₂, LiN(SO₂F₂)₂, LiCF₃SO₃, LiC₄F₉SO₃, LiC₆H₅SO₃, LiSCN, LiAlO₂, LiAlCl₄, LiN(CₓF₂ₓ₊₁SO₂)(C_{y}F_{2y+1}SO₂) (where x and y are natural numbers), LiCl, LiI, and LiB (C₂O₄)₂.

10. A lithium secondary battery comprising:
electrodes comprising a cathode and an anode;
a separator disposed between the electrodes; and
an electrolyte comprising a lithium salt, a solvent component and an additive;
wherein the additive comprises a compound represented by Chemical formula (1) below, 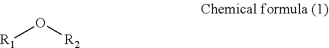
wherein the R₁ and R₂ are each independently a linear or a branched alkyl group having 2 to 6 carbon atoms and containing 3 or more fluorine atoms.

11. The lithium secondary battery of claim 10, wherein the additive has a LUMO energy of about −0.6 eV or less.

12. The lithium secondary battery of claim 10, wherein the cathode comprises a cathode active material comprising Ni, Co, and Mn, wherein an amount of Ni is in the range of 60 to 99 wt % based on the total weight of the cathode active material.

13. The lithium secondary battery of claim 10, wherein the anode comprises an anode active material comprising an amount of about 5 to 90 wt % of Si based on the total weight of the anode active material.

14. The lithium secondary battery of claim 10, wherein the lithium secondary battery has an ion conductivity of about 8.25 mS/cm or greater.

15. The lithium secondary battery of claim 10, wherein the lithium secondary battery has about 70% or greater of an initial discharge capacity after 150 charging/discharging cycles at a temperature of about 25° C.

16. The lithium secondary battery of claim 10, wherein the lithium secondary battery has about 60% or greater of an initial discharge capacity after 200 charging/discharging cycles at a temperature of about 45° C.

17. The lithium secondary battery of claim 10, wherein the lithium secondary battery has a resistance of about 7 Ω or less after 200 charging/discharging cycles at a temperature of about 45° C.

18. The lithium secondary battery of claim 10, wherein the lithium secondary battery has 55% or more of an initial discharge capacity after 140 charging/discharging cycles at a temperature of about 60° C.

19. A vehicle comprising a lithium secondary battery of claim 10.
